(19) United States
(12) Patent Application Publication
(10) Pub. No.: US 2010/0270981 A1
(43) Pub. Date: Oct. 28, 2010

(54) POWER SOURCE APPARATUS AND SECONDARY BATTERY CHARGE CONTROL METHOD

(75) Inventor: Hirohito MOTOMIYA, Higashiyamato-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/769,539

(22) Filed: Apr. 28, 2010

(30) Foreign Application Priority Data
Apr. 28, 2009 (JP) 2009-109797

(51) Int. Cl. H02J 7/04

(52) U.S. Cl. 320/160

(57) ABSTRACT

According to one embodiment, a power source apparatus includes a secondary battery, an input terminal that inputs charging power for the secondary battery, a voltage measuring module which measures a voltage magnitude of power input from the input terminal, a switch that controls a charging current magnitude of the secondary battery stepwise, and a controller which controls a charging operation of the secondary battery. The controller controls the switch to gradually increase the charging current magnitude of the secondary battery from zero when the controller detects that input of the charging power from the input terminal is started, based on a measurement result of the voltage measuring module, and stops the increase of the charging current magnitude when the voltage magnitude measured by the voltage measuring module becomes a predetermined value lower than the lower limit of a preset range.

### CROSS-REFERENCE TO RELATED APPLICATIONS

This application is based upon and claims the benefit of priority from Japanese Patent Application No. 2009-109797, filed Apr. 28, 2009, the entire contents of which are incorporated herein by reference.

### BACKGROUND

1. Field

One embodiment of the invention relates to a secondary battery charge control technique adequately used for a second battery unit or the like of a battery-drivable notebook personal computer (PC), for example.

2. Description of the Related Art

Recently, for example, an electronic apparatus such as a notebook PC or cellular telephone that can be battery-driven and easily carried is widely used. As one of power supply sources (batteries) of this type of electronic apparatus, a lithium-ion battery is used.

Most of the lithium-ion batteries are formed with structures that are not suitable to be charged with a large current. Generally, it is roughly said that the maximum charging current of the lithium-ion battery is approximately equal to 1 C (C=charging current/rated capacity). Therefore, even if it is charged with the maximum charging current, it is required to take a long time of 2 to 3 hours. Based on this situation, recently, a lithium-ion battery (that is hereinafter referred to as a new battery) that can be charged with a large current of approximately 10 to 20 C is developed.

However, in order to contain the new battery in an existing electronic apparatus, it is necessary to change the substrate pattern and circuit parts and change a charging external power source to a larger-capacity power source so as to charge the battery with a large current.

In the portable electronic apparatus, a second battery unit may be connected as required in addition to a built-in battery as the power supply source. If the new battery is used for the second battery unit, the new battery that can be rapidly charged can be used without modifying the existing electronic apparatus at all.

As described before, the new battery can be charged by a large current of 10 to 20 C, but the charging power source becomes extremely larger in size. Therefore, carrying the charging power source imposes a heavy load on the user.

Therefore, it is considered to use different measures, for example, charge the new battery by means of a charging power source which is not too bulky to carry and does not impose a heavy load (although the charging current thereof is small) when it is carried and use a large-size charging power source that can rapidly charge the new battery (whose charging current is large) when it is installed in an office. At the time of charging the battery, it is necessary to perform the operation of adequately changing the setting value of the protection function according to the charging current. Various mechanisms for performing the above control operation are proposed (for example, see Jpn. Pat. Appln. KOKAI Publication No. 2003-189501).

In the charging apparatus described in Jpn. Pat. Appln. KOKAI Publication No. 2003-189501, it is supposed that the built-in battery is charged by means of an external power source whose rating is previously made clear and the control operation is performed to prevent a supply current from the external power source from exceeding a total magnitude of the charging current of the battery and the consumption current of the main body of the portable information terminal. Therefore, when an external power source whose rating is not made clear is connected, there occurs a problem that an expected operation cannot be performed.

For example, even if an external power source having large rating (capable of supplying a larger current than in the conventional case) is connected, a problem that the charging current cannot be changed in accordance with the rating of the external power source may occur.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing one example of a utilization form of a power source apparatus according to an embodiment of the invention.

FIG. 2 is an exemplary flowchart illustrating the operation of the power source apparatus of the embodiment when a charging power source is connected thereto.

### DETAILED DESCRIPTION

Various embodiments according to the invention will be described hereinafter with reference to the accompanying drawings. In general, according to one embodiment of the invention, a power source apparatus includes a secondary battery, an input terminal that inputs charging power for the secondary battery, a voltage measuring module which measures a voltage magnitude of power input from the input terminal, a switch that controls a charging current magnitude of the secondary battery stepwise, and a controller which controls a charging operation of the secondary battery. The controller controls the switch to gradually increase the charging current magnitude of the secondary battery from zero when the controller detects that input of the charging power from the input terminal is started, based on a measurement result of the voltage measuring module, and stops the increase of the charging current magnitude when the voltage magnitude measured by the voltage measuring module becomes a predetermined value lower than the lower limit of a preset range.

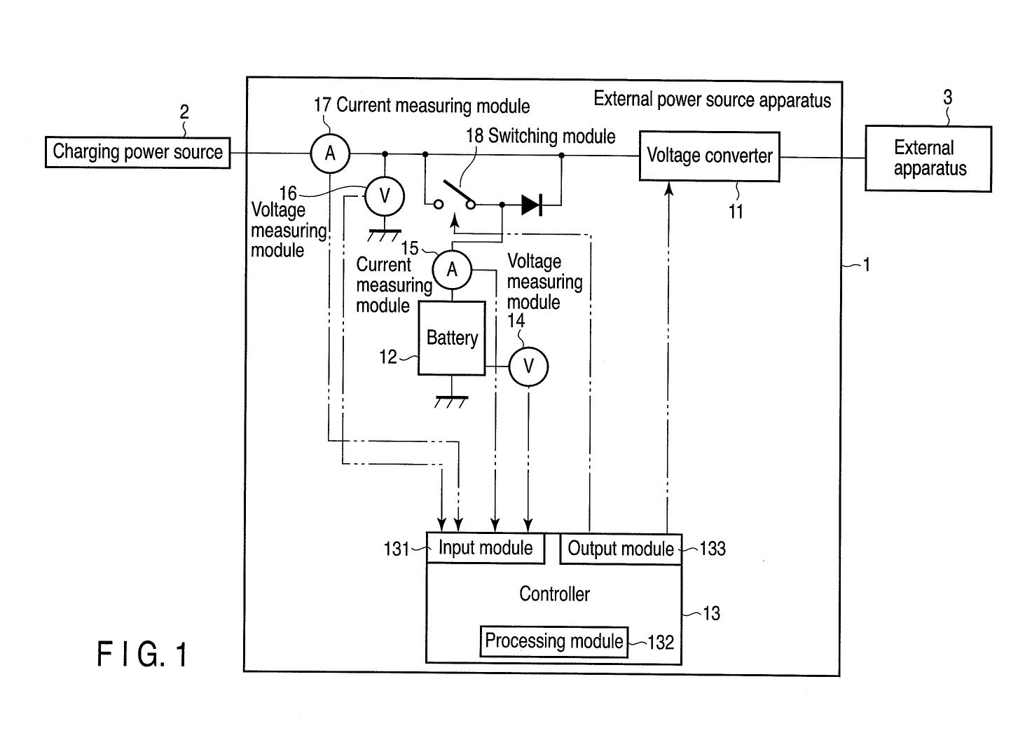

FIG. 1 is an exemplary diagram showing one example of a utilization form of a power source apparatus (external power source apparatus 1) according to an embodiment of the invention. For example, the external power source apparatus 1 is realized as a second battery unit of an external apparatus 3 that is a notebook PC or cellular telephone and a battery 12 capable of supplying power to the external apparatus 3 via a voltage converter 11 is contained therein. When a charging power source 2 that is an AC adapter or the like is connected to the external power source apparatus 1, the battery 12 can be charged with power from the charging power source 2. Power from the charging power source 2 can be used to charge the battery 12 and can be supplied to the external apparatus 3.

The voltage converter 11 is a converter that converts voltage from the battery 12 or charging power source 2 to voltage required by the external apparatus 3 and controls the on/off operation of voltage conversion according to a signal from an output module 133 of a controller 13. The controller 13 includes an input module 131 that inputs information used to determine the operation of the external power source apparatus 1, a processing module 132 that determines the operation of the external power source apparatus 1 based on information received via the input module 131 and an output module 133 that outputs information used to cause the external power source apparatus 1 to perform the operation determined by the processing module 132.

A voltage measuring module 14 and current measuring module 15 convert a voltage magnitude and charging/discharging current magnitude of the battery 12 into voltage magnitudes (indicating the voltage magnitude or charging/discharging current magnitude) according to respective preset rules and supply them to the input module 131 of the controller 13.

Likewise, a voltage measuring module 16 and current measuring module 17 convert a voltage magnitude and current magnitude of the charging power source 2 into voltage magnitudes (indicating the voltage magnitude or current magnitude) according to respective preset rules and supply them to the input module 131 of the controller 13.

A switching module 18 can be turned on/off according to a signal from the output module 133 of the controller 13 and controls the charge on/off state of the battery 12 by means of power from the charging power source 2.

Next, the operation principle of the external power source apparatus 1 with the above configuration when the charging power source 2 is connected thereto is explained. In this case, the processing module 132 of the controller 13 can detect that charging power starts to be input, that is, the charging power source 2 is connected according to a voltage measured by the voltage measuring module 16.

When the charging power source 2 is connected to the external power source apparatus 1 and if a voltage (Vadp) measured by the voltage measuring module 16 lies within a preset range, it is determined as an adaptable power source by the processing module 132 of the controller 13. The voltage (Vadp) obtained at this time is set as an initial voltage (Vadp_ini).

If the adaptable power source is determined, the processing module 132 of the controller 13 outputs a signal indicating that the charging operation for the battery 12 is started via the output module 133 to control the switching module 18. Further, at this time, the processing module 132 of the controller 13 controls the switching module 18 so as to increase a charging current (Ichg) gradually or in stages from zero while monitoring the charging current (Ichg) of the battery 12 by means of the current measuring module 15.

The processing module 132 of the controller 13 determines that the charging current has reached the rating of the charging power source 2 when the voltage monitored by the voltage measuring module 16 becomes lower than, for example, 10% of the initial voltage (Vadp_ini) (hereinafter referred to as “detection A”) in the course of increasing the charging current (Ichg). Then, the processing module 132 of the controller 13 holds a value (Iadp_max−5%) that is smaller by, for example, 5% of the supply current (Iadp_max) measured by the current measuring module 17 at this time point and a charging current (Ichg_max_{—}0) measured by the current measuring module 15 as data (identification result) relating to the power supply capacity of the charging power source 2. The processing module 132 of the controller 13 continuously holds the supply current (Iadp_max_{—}0, that is, Iadp_max−5%) and the charging current (Ichg_max_{—}0) until the charging power source 2 is disconnected.

Further, when the charging current (Ichg) reaches the maximum charging current of the battery 12 before it is determined that charging current reaches the rating of the charging power source 2 (hereinafter referred to as “detection B”) in the course of increasing the charging current (Ichg), the processing module 132 of the controller 13 holds a supply current (Iadp_max_{—}1) measured by the current measuring module 17 at this time point and a charging current (Ichg_max_{—}1) measured by the current measuring module 15 as data (identification result) relating to the power supply capacity of the charging power source 2. The processing module 132 of the controller 13 continuously holds the supply current (Iadp_max_{—}1) and the charging current (Ichg_max_{—}0) until the charging power source 2 is disconnected.

In the case of “detection A”, it can be determined that the supply power of the charging power source 2 is insufficient to charge with the maximum charging current of the battery 12. In this case, the processing module 132 of the controller 13 controls the switching module 18 so as to prevent the power from exceeding the power supply capacity of the charging power source 2 measured at the time of “detection A”.

On the other hand, in the case of “detection B”, it can be determined that the charging power source 2 can supply sufficient power to charge with the maximum charging current of the battery 12. In this case, the processing module 132 of the controller 13 controls the switching module 18 so as to charge with the maximum charging current when the battery 12 is charged. Note, even if it is charged with the maximum charging current, the voltage of the charging power source 2 is monitored by means of the voltage measuring module 16 by considering a state in which power is supplied to the external apparatus 3. If the monitored voltage becomes lower than, for example, 10% of the initial voltage (Vadp_ini), the detection result is changed from “detection B” to “detection A” and a value that is lower than, for example, 5% of the supply current (Iadp) at this time is held as the supply current maximum magnitude (Iadp_max_{—}0, that is, Iadp_max−5%).

Thus, the external power source apparatus 1 permits the battery 12 to be charged with the maximum capacity of the charging power source 12 connected thereto and can attain the safety by changing a value relating to the protection function of the battery 12 to an adequate value.

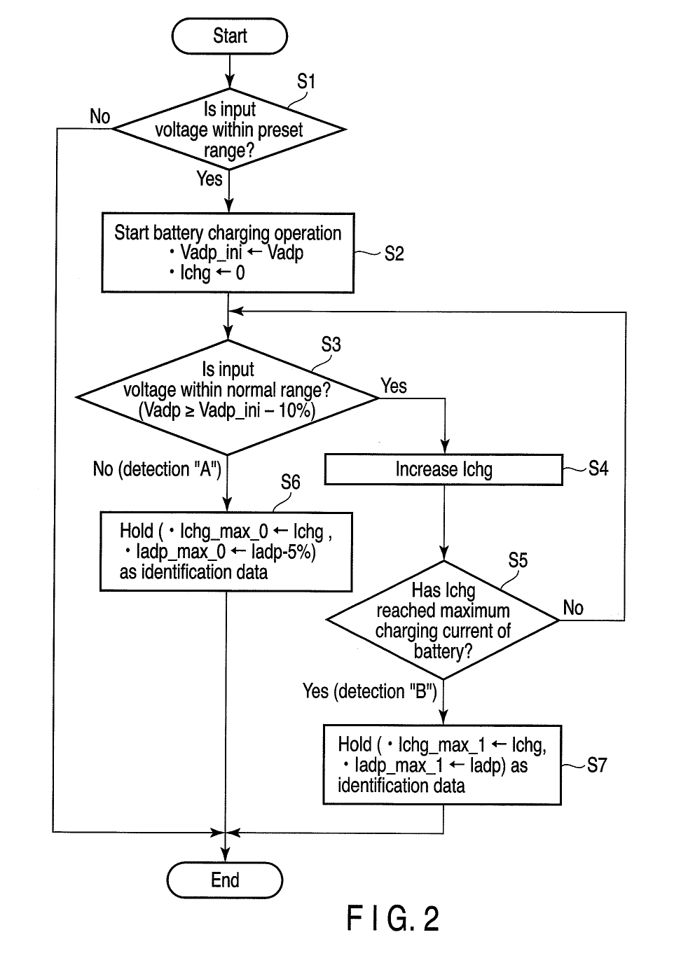

FIG. 2 is an exemplary flowchart illustrating the operation of the external power source apparatus 1 when the charging power source 2 is connected thereto.

The processing module 132 of the controller 13 first checks whether or not a voltage measured by the voltage measuring module 16 lies within a preset range (block S1). If the voltage lies within the preset range, that is, if the charging power source 2 is an adequate power source (YES in block S1), the processing module 132 of the controller 13 starts to charge the battery 12 so that the charging current will gradually increase from zero (block S2).

When the voltage monitored by the voltage measuring module 16 becomes lower than a preset range from the initial voltage (NO in block S3) in the course of increasing the charging current (YES in block S3, block S4, NO in block S5), the processing module 132 of the controller 13 determines that the rating of the charging power source 2 is reached. At this time, the processing module 132 of the controller 13 holds a value obtained by subtracting a preset value from a supply current measured by the current measuring module 17 at this time point and a charging current measured by the current measuring module 15 as identification data of the charging power source 2 (block S6).

When the charging current has reached the maximum charging current of the battery 12 (YES in block S5) before it is determined that the rating of the charging power source 2 is reached in the course of increasing the charging current, the processing module 132 of the controller 13 holds a supply current measured by the current measuring module 17 at this time point and a charging current measured by the current measuring module 15 as identification data of the charging power source 2 (block S7).

As described above, according to the external power source apparatus 1, the function of automatically identifying the power supply capacity of the charging power source to determine the maximum charging current of the secondary battery and adequately changing the set value of the protection function can be realized.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power source apparatus configured to supply electric power to an information processing apparatus and is configured to connect to the information processing apparatus, comprising:
a secondary battery;
an input terminal configured to receive power to be charged to the secondary battery;
a first voltmeter configured to measure a voltage of the power;
a switch configured to stepwise control a charging current of the secondary battery; and
a controller configured to control a charging operation of the secondary battery,
wherein the controller is configured to control the switch in order to gradually increase the charging current of the secondary battery from zero when the controller detects that a reception of the power from the input terminal is present, based on a measurement result of the first voltmeter, and to stop the increase of the charging current when the measured voltage becomes lower than a predetermined value.

2. The apparatus of claim 1, wherein the controller is configured to stop the increase of the charging current when the charging current reaches an allowable charging current of the secondary battery before the measured voltage reaches the predetermined value.

3. The apparatus of claim 1, wherein the controller is configured to store data indicating power supply capacity from the input terminal determined during the increase of the charging current, and to control the charging operation of the secondary battery according to the power supply capacity indicated by the data, until when the controller detects a termination of the reception of the power from the input terminal, based on a measurement result of the first voltmeter.

4. The apparatus of claim 3, wherein the control of the charging operation of the secondary battery comprises a configuration of a protection function of the secondary battery.

5. The apparatus of claim 3, wherein the power supply capacity comprises a charging current amount calculated by subtracting a predetermined current value from the charging current when the increase of the charging current magnitude is stopped because the measured voltage becomes lower than the predetermined value.

6. The apparatus of claim 3, further comprising a second voltmeter configured to measure a charging voltage of the secondary battery,
wherein the controller is configured to control the switch in order to decrease the charging current of the secondary battery when a charging voltage measured by the second voltmeter decreases as the secondary battery is charged according to the power supply capacity indicated by the data.

7. A secondary battery charge control method of a power source apparatus that comprises a secondary battery and an input terminal configured to receive power for the secondary battery, the method comprising:
gradually increasing the charging current of the secondary battery from zero when a reception of the power from the input terminal is present; and
stopping the increase of the charging current when a voltage at the input terminal becomes lower than a predetermined value.

8. The method of claim 7, further comprising stopping the increase of the charging current when the charging current reaches an allowable charging current of the secondary battery before the voltage at the input terminal reaches the predetermined value.
